(19) United States
(12) Patent Application Publication
(10) Pub. No.: US 2023/0376999 A1
(43) Pub. Date: Nov. 23, 2023

(54) ANALYZING JOB PROFILE DATA

(71) Applicant: HG Insights, Inc, Santa Barbara, CA (US)

(72) Inventors: Robert J. Fox, Santa Barbara, CA (US); Lauren Wong, Santa Barbara, CA (US)

(21) Appl. No.: 17/747,752

(22) Filed: May 18, 2022

(51) Int. Cl. G06Q 30/02

(52) U.S. Cl. CPC G06Q 30/0255; G06Q 30/0202; G06Q 30/0201

(57) ABSTRACT

Job profile data analysis implementations that are described herein generally analyzes job profile data, and in various implementations uses the analysis to identify marketing and sales opportunities and threats. More particularly, the job profile data is used to identify individuals who have recently changed jobs and have taken on a decision maker or influencer role in their new job with regard to the purchase of products and/or services. Marketing and sales opportunities and threats are gleaned from this knowledge and the knowledge of what products and services were used in the individual's previous and new jobs.

### BACKGROUND

Advertisers, product manufacturers and technology vendors continually seek ways to identify potential customers who may purchase their products. This allows these entities to better target potential customers. The better the method of identifying these customers, the better the results. For example, blanket advertisements and blind contacts are less efficient, more costly, and often less effective than targeted marketing to potential customer who are believed to have an interest in purchasing a product. Ultimately, having knowledge of who is more likely to buy a product will lead to more sales.

### SUMMARY

Job profile data analysis implementations described herein generally analyze job profiles, and in various implementations uses the analysis to identify marketing and sales opportunities and threats. One exemplary implementation takes the form of a system for analyzing job profile data which includes a job profile data analyzer having one or more computing devices, and a job profile data analysis computer program having a plurality of sub-programs executable by the computing device or devices. The sub-programs configure the computing device or devices to access job profile data collected over a prescribed period of time, where the job profile data includes job holder identifiers, as well as at least one of job titles, job descriptions, job locations, functional areas of an employing entity, start dates of jobs, end dates of jobs, and employing entity information including an employing entity identifier, that are associated with each job holder. The job profile data is next analyzed to identify job holders that have changed jobs from one employing entity to another. For each job holder found to have changed jobs from one employing entity to another, it is then determined if the job holder is in a job at their current employing entity that involves purchasing or recommending the purchase of products, or services, or both. Job titles and functional areas where a job holder works are particularly useful in determining the job holder's purchasing and recommending status. The job title and functional area information is derived from the job profile data, either directly, or in the case of a functional area, in one implementation using a functional area classifier. A report is then generated that includes a listing for each job holder found to have changed jobs from one employing entity to another and determined to be in a job at their current employing entity that involves purchasing or recommending the purchase of products, or services, or both.

Another exemplary implementation includes sub-programs that configure the computing device or devices to access job profile data collected over a prescribed period of time, where the job profile data includes job holder identifiers, as well as at least one of job titles, job descriptions, job locations, functional areas of an employing entity, start dates of jobs, end dates of jobs, and employing entity information including an employing entity identifier, that are associated with each job holder. The job profile data is next analyzed to identify job holders that have changed jobs within an employing entity. For each job holder found to have changed jobs within an employing entity, it is determined if the job holder's current job at their employing entity involves purchasing or recommending the purchase of products, or services, or both. Next, a report is generated that includes a listing for each job holder found to have changed jobs within an employing entity and whose current job at their employing entity involves purchasing or recommending the purchase of products, or services, or both.

Yet another exemplary implementation takes the form of a computer-implemented process for analyzing job profile data. This process uses one or more computing devices to perform a number of process actions. If a plurality of computing devices is employed, the computing devices are in communication with each other via a computer network. A first of the process actions involves accessing job profile data collected over a prescribed period of time, where the job profile data includes job holder identifiers, as well as at least one of job titles, job descriptions, job locations, functional areas of an employing entity, start dates of jobs, end dates of jobs, and employing entity information including an employing entity identifier, that are associated with each job holder. The job profile data is analyzed to identify job holders that have changed jobs from one employing entity to another. For each job holder found to have changed jobs from one employing entity to another, it is determined if the job holder is in a job at their current employing entity that involves purchasing or recommending the purchase of products, or services, or both. A report is then generated that includes a listing for each job holder found to have changed jobs from one employing entity to another and determined to be in a job at their current employing entity that involves purchasing or recommending the purchase of products, or services, or both.

With regard to those job holders found to have changed jobs and determined to be in a current job that involves purchasing or recommending the purchase of products, or services, or both, information about what products and services were used in the functional area where the job holder used to work, as well as what products and services are used in the functional area where the job holder is now working, is accessed. This information is then analyzed to identity marketing and sales opportunities and threats. For example, in one implementation, the product and service information is used to identify one or more products or services, or both, that were used by the functional area that the job holder worked in previously and not used but likely needed by the functional area that the job holder works in currently. The job holder is then designated as likely to purchase or suggest purchasing the identified products and services. Other examples will be described in the sections to follow.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the job profile data analysis implementations described herein will become better understood with regard to the following description, appended claims, and accompanying drawings where:

FIG. 1 is a diagram illustrating one implementation, in simplified form, of a system framework for realizing the job profile data analysis implementations described herein.

FIG. 2 is a diagram illustrating one implementation, in simplified form, of the sub-programs included in the job profile data analysis computer program which includes identifying job holders that have changed jobs from one employing entity to another employing entity.

FIG. 3 is a flow diagram illustrating an exemplary implementation, in simplified form, of a process for determining if a job holder is a decision maker or influencer in their job using a database of job titles.

FIG. 4 is a flow diagram illustrating an exemplary implementation, in simplified form, of a process for determining if a job holder is a decision maker or influencer in their job using a database of job titles and functional area combinations.

FIG. 5 is a simplified example of a part of one implementation of a job profile data analysis report.

FIGS. 6A-B are a flow diagram illustrating an exemplary implementation, in simplified form, of a process for analyzing job profile data.

FIG. 7 is a flow diagram illustrating an exemplary implementation, in simplified form, of a process for accessing product and service purchasing information about previous and new employing entities associated with a job change of a job holder that has decision making or influencing authority in their new job, and analyzing the product and service purchasing information to identity marketing and sales opportunities and threats where a product or service was used in a functional area of the previous employing entity where the job holder previously worked but is not used in a functional area of the new employing entity where the job holder now works.

FIG. 8 is a flow diagram illustrating an exemplary implementation, in simplified form, of a process for accessing product and service purchasing information about previous and new employing entities associated with a job change of a job holder that has decision making or influencing authority in the new job, and analyzing the product and service purchasing information to identity marketing and sales opportunities and threats where a product or service used in a functional area of the previous employing entity where the job holder previously worked is used in a functional area of the new employing entity where the job holder now works, but purchased from a different vendor.

FIG. 9 is a flow diagram illustrating an exemplary implementation, in simplified form, of a process for accessing product and service purchasing information about previous and new employing entities associated with a job change of a job holder that has decision making or influencing authority in the new job, and analyzing the product and service purchasing information to identity marketing and sales opportunities and threats where a product or service purchased from a particular vendor was used in a functional area of the previous employing entity where the job holder previously worked but is not needed in a functional area of the new employing entity where the job holder now works.

FIG. 10 is a table identifying marketing and/or sales opportunities or threats for various vendors (i.e., a vendor of technology at a prior employing entity, a vendor of technology at the current employing entity, and a vendor of technology that competes with one or both of these vendors) considering various exemplary scenarios involving the use of products and/or services at a job holder's prior and current jobs.

FIG. 11 is a diagram illustrating one implementation, in simplified form, of the sub-programs included in the job profile data analysis computer program which includes identifying job holders that have changed jobs within the same employing entity.

FIG. 12 is a diagram illustrating a simplified example of a general-purpose computer system on which various implementations and elements of the job profile data analysis technique, as described herein, may be realized.

### DETAILED DESCRIPTION

In the following description of job profile data analysis implementations reference is made to the accompanying drawings which form a part hereof, and in which are shown, by way of illustration, specific implementations in which the job profile data analysis can be practiced. It is understood that other implementations can be utilized, and structural changes can be made without departing from the scope of the job profile data analysis implementations.

It is also noted that for the sake of clarity specific terminology will be resorted to in describing the entity functional area and product use identification implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “some implementations”, or “one tested implementation”; or “one version”, or “another version”, or an “exemplary version”, or an “alternate version”, or “some versions”, or “one tested version”; or “one variant”, or “another variant”, or an “exemplary variant”, or an “alternate variant”, or “some variants”, or “one tested variant”; means that a particular feature, a particular structure, or particular characteristics described in connection with the implementation/version/variant can be included in one or more implementations of the entity functional area and product use identification. The appearances of the phrases “in one implementation”, “in another implementation”, “in an exemplary implementation”, “in an alternate implementation”, “in some implementations”, “in one tested implementation”; “in one version”, “in another version”, “in an exemplary version”, “in an alternate version”, “in some versions”, “in one tested version”; “in one variant”, “in another variant”, “in an exemplary variant”, “in an alternate variant”, “in some variants” and “in one tested variant”; in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the entity functional area and product use identification does not inherently indicate any particular order nor imply any limitations thereto.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive, in a manner similar to the term “comprising”, as an open transition word without precluding any additional or other elements.

It is also noted that for the purposes of the following description and claims, the term employing entity generally refers to a natural entity such as an individual person; a business entity such as an association, corporation, partnership, company, proprietorship, or trust; or a governmental entity such as a university or institute; among others. The term job holder generally refers to an individual holding any form of employment with an employing entity including as an employee, contractor, consultant, trainee, intern, and so on. The term functional area of an employing entity generally refers to a department, group, team, branch, division, unit, section, or any other sub-part of a company. Some common functional areas include Finance, Operations, Human Resources, Sales, Administration, IT, Supply, Customer Success or Service, Engineering, Marketing, Management, and Science, among others.

1.0 Job Profile Data Analysis

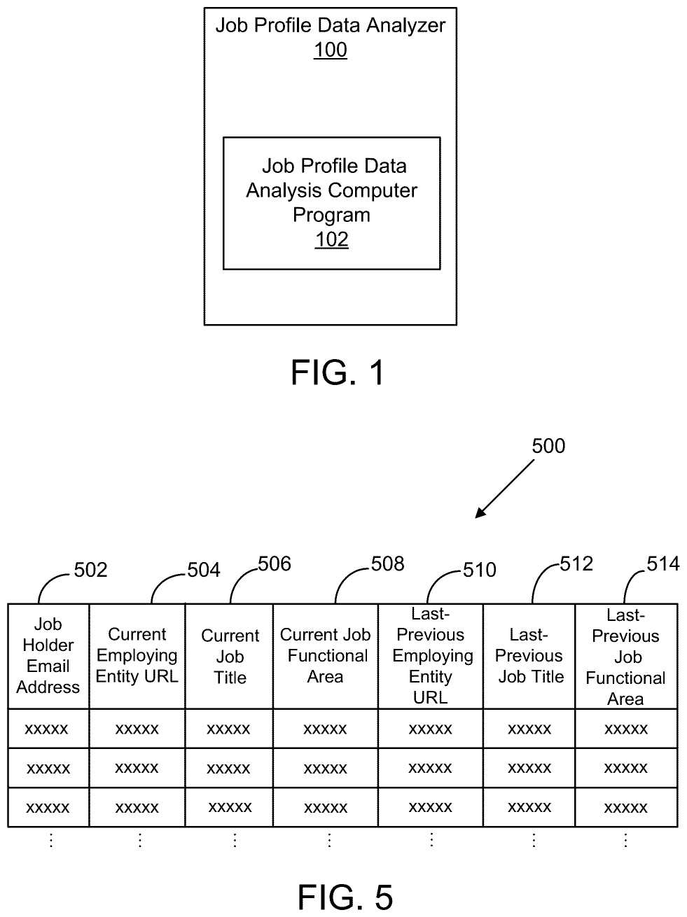

Job profile data analysis implementations that are described herein generally analyzes job profiles, and in various implementations uses the analysis to identify marketing and sales opportunities and threats. FIG. 1 illustrates one implementation, in simplified form, of a system framework for realizing the job profile data analysis implementations described herein. As exemplified in FIG. 1, the system framework includes a job profile data analyzer including one or more computing devices 100, and a job profile data analysis computer program 102 having a plurality of sub-programs executable by the computing device or devices of the analyzer.

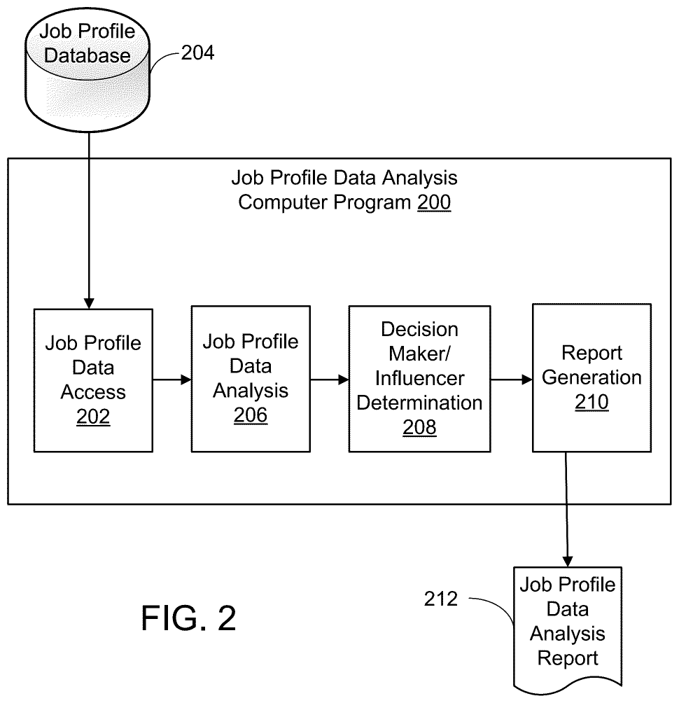

FIG. 2 illustrates one implementation, in simplified form, of the sub-programs included in the job profile data analysis computer program 200 that configure the aforementioned computing device or devices. More particularly, a job profile data access sub-program 202 is included as shown in FIG. 2. The access sub-program 202 receives input data form a job profile database 204. In one implementation, the input data is in the form of job holder identifiers (e.g., name, email address, and so on), as well as other items associated with each identified job holder such as at least one of the job holder's job titles, job descriptions, job locations, functional areas of an employing entity, start dates of jobs, end dates of jobs, and employing entity information including an employing entity identifier. The accessed job profile data represents data collected over a prescribed period of time. For example, in a tested implementation the prescribed period of time was the previous 90 days. However, it is not intended that the job profile data analysis implementations described herein be limited to a 90-day collection period. Rather, longer and shorter periods of time may be used depending on the quantity and accuracy of the data. In general, the source of the job profile data can be any database that includes the foregoing types of job data. For example, such data is available from LinkedIn Corporation, as well as various job resume and job listing databases. In addition, the job profile database 204 can include a combination of job profile data taken from more than one source.

The job profile data analysis computer program 200 also includes a job profile data analysis sub-program 206 as shown in FIG. 2. In general, the analysis sub-program 206 uses the job profile data to identify job holders that have recently (e.g., in the last 90 days) changed jobs. In one implementation, job holders are identified that have changed jobs from one employing entity to another. This can include making sure the “new” job is not a second job or a hobby by looking, for example, at the start and end dates gleaned from the job profile data. For example, if a new employing entity is listed for an individual in the job profile data, and there is a closure date listed for an immediately preceding job, this would indicate the individual is working for a different employing entity.

The job profile data analysis computer program 200 further includes a decision maker/influencer determination sub-program 208 as shown in FIG. 2. In general, the determination sub-program 208 uses the job profile data to determine if a job holder is in a job at their current employing entity which involves purchasing or recommending the purchase of products, or services, or both. This is done for each job holder previously found to have changed jobs from one employing entity to another. A decision maker is generally someone who has direct control over whether a product or service is purchased for an employing entity, whereas an influencer is generally a person who is in a position to recommend what products and/or services are purchased by an employing entity.

Job titles and functional areas where a job holder works are particularly useful in identifying a decision maker or influencer that is involved in purchasing products and services for an employing entity. As indicated previously, the job profile data can contain job titles and functional area designations associated with a job holder. In addition, a functional area can be determined using a functional area classifier, such as the functional area classifier described in “U.S. patent application Ser. No. 17/193,992, Unpublished (filing date Mar. 5, 2021) (HG Insights Inc., applicant)”. Still further, if some information is missing or uncertain (for example, if a functional area classifier outputs a functional area designation, but the certainty level is lower than a prescribed threshold), a second source of information can be used to obtain the missing data or increase the confidence level of uncertain data. For example, the aforementioned job listings and resume databases are a good source for job title and functional area designations, as well as other information.

More particularly, job titles provide clues as to whether a person is a decision maker or influencer. For example, it is generally known that account managers and customer success managers tend not to be decision makers or influencer with regard to purchasing products and services for an employing entity. On the other hand, it is generally known that directors of marketing do have decision maker status and marketing managers often have influencer status.

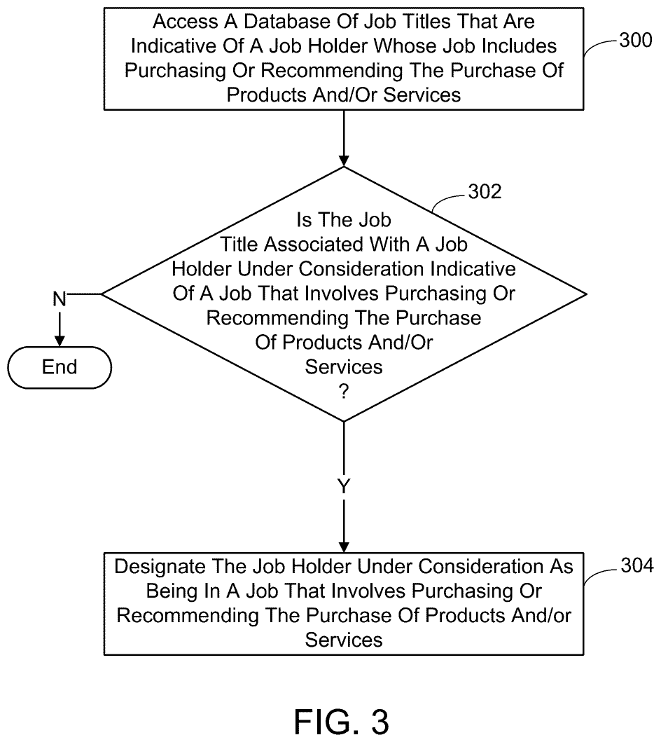

One way to determine if an individual is a decision maker or influencer in their new job is to consult a decision maker database that lists job titles and whether a person having such a job title is a decision maker, or an influencer, or neither. More particularly, referring to FIG. 3, in one implementation, determining if a job holder is a decision maker or influencer in their job includes first accessing a database of job titles that are indicative of a job holder whose job includes purchasing or recommending the purchase of products, or services, or both (process action 300). It is then ascertained if the job title associated with a job holder under consideration at an employing entity is listed in the job titles database as being indicative of a job holder whose job includes purchasing or recommending the purchase of products, or services, or both (process action 302). If so, the job holder under consideration is designated as being in a job that involves purchasing or recommending the purchase of products, or services, or both (process action 304). In other words, the job holder is a decision maker or influencer. If, however, it is ascertained that the job title associated with a job holder under consideration is not indicative of a job holder whose job includes purchasing or recommending the purchase of products, or services, or both, then the process ends.

Knowing the functional area a person works at in their new job and in their previous job can be advantageously employed to infer if it is the kind of functional area that purchases products and service. In addition, this type of information can be useful in determining what type of products and services the person might be interested in purchasing in his or her new job for the new employing entity, among other things (as will be discussed in more detail later).

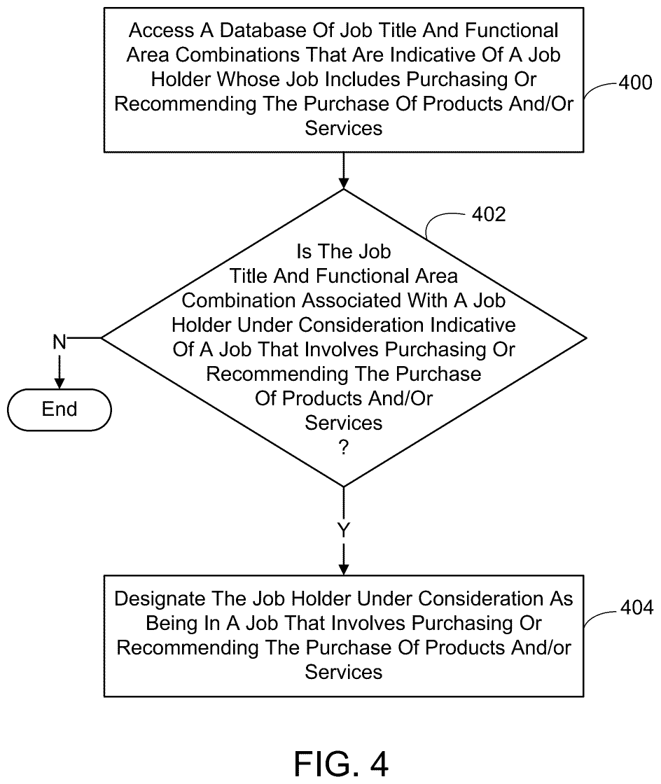

Given the foregoing, another way to determine if an individual is a decision maker or influencer in their new job is to consult a decision maker database that lists not just job titles, but job title and functional area combinations, and indicates whether a person having such a particular job title and functional area combination is a decision maker, or an influencer, or neither. More particularly, referring to FIG. 4, in one implementation, determining if a job holder is a decision maker or influencer in their job includes first accessing a database of job titles and functional area combinations that are indicative of a job holder whose job includes purchasing or recommending the purchase of products, or services, or both (process action 400). It is then ascertained if the job title and functional area combination associated with a job holder under consideration at an employing entity is listed in the job title-functional area database as being indicative of a job holder whose job includes purchasing or recommending the purchase of products, or services, or both (process action 402). If so, the job holder under consideration is designated as being in a job that involves purchasing or recommending the purchase of products, or services, or both (process action 404). If, however, it is ascertained that the job title and functional area combination associated with a job holder under consideration is not indicative of a job holder whose job includes purchasing or recommending the purchase of products, or services, or both, then the process ends.

It is recognized that a decision maker database as described above may be proprietary, or otherwise not be readily available. However, yet another way to use job title information to determine if an individual is a decision maker or influencer (or neither) is to build a decision maker classifier using, for example, supervised machine learning (SML) techniques. Supervised machine learning involves generating a function that maps an input to an output based on example input-output training pairs. More particularly, a supervised learning algorithm analyzes a training data set and produces an inferred function, which can be used for mapping new examples.

In one implementation, job titles found in the job profile data are employed to create the training data set used to train the decision maker classifier. To this end, each job title is preprocessed as required by the particular SML technique being employed to create the input part of an input-output training pair. The input part is manually tagged with a decision maker label, or an influencer label, or individual label (i.e., not a decision maker or influencer) based on known associations. For example, job titles with terms like “director of” or “head of” tend to be decision makers; and job titles with terms like “manager of” tend to be influencers. The aforementioned label represents the output part of the input-output training pair. Multiple input-output training pairs are created in the same manner. In addition, the functional area associated with a job title can be included as part of the input data since the functional area can play into whether an individual with a particular job title is a decision maker or influencer with regard to purchasing products and services, as described previously. It is noted, however, the decision maker classifier is not limited to just SML techniques. In general, any machine learning technique, supervised or unsupervised (e.g., a neural network approach), can be employed to generate the classifier.

In operation, the decision maker classifier (which has been trained as described previously), is used to identify whether a job title (and optionally the functional area) is indicative of a decision maker or an influencer or neither. It is noted that the training data used to train the classifier, as well as new inputs and the resulting outputs, can be used to create the aforementioned decision maker database. The decision maker database can then be used before resorting to the classifier to determine if an individual is a decision maker or influencer in their new job. This simplifies the process. Further, as more entries are made in the decision maker database, they can be used as new training data to refine the decision maker classifier.

It is also advantageous to know if an identified job holder was a decision maker or influencer in their previous job. The previously described procedures for determining the job holder's decision maker/influencer/individual status are employed to determine if the job holder was a decision maker or influencer in their previous job (or not). The usefulness of knowing this information will be described in sections to follow.

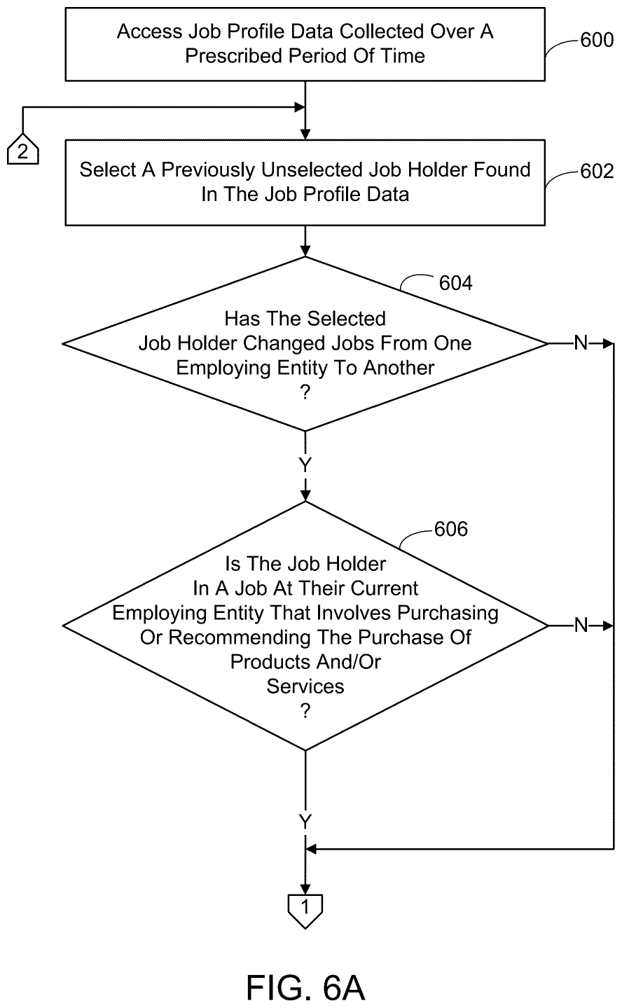

Referring once again to FIG. 2, the job profile data analysis computer program 200 further includes a report generation sub-program 210. In general, the report generation sub-program 210 generates a job profile data analysis report 212 that includes a listing for each job holder found to have changed jobs from one employing entity to another and determined to be in a job at their current employing entity that involves purchasing or recommending the purchase of products, or services, or both. More particularly, referring to FIG. 5, in one implementation, the job profile data analysis report 500 lists a job holder identifier associated with the job holder 502. In the example shown in FIG. 5, the job holder identifier 502 is an email address. However, any type of identifier can be used instead, such as a LinkedIn profile Uniform Resource Locator (URL), name, and so on. Each entry in the job profile data analysis report 500 also lists the identifier associated with the job holder's current employing entity 504. In the example shown in FIG. 5, the current employing entity identifier 504 is a URL. However, any type of identifier can be used instead, such as a company name. In one implementation, the job profile data analysis report 500 also lists the job title associated with the job holder's current job 506, as well as the name of the functional area 508 of the current employing entity where the job holder works. In some implementations, each job holder entry of the job profile data analysis report 500 further includes the identifier associated with the job holder's last-previous employing entity 510, the job title associated with the job holder's last-previous job 512, and the name of the functional area 514 of the last-previous employing entity where the job holder worked. It is noted that the job profile data analysis report 500 shown in FIG. 5 is a simplified exemplary report showing just a few entries. It is noted that an actual job profile data analysis report could contain thousands of entries like those shown in FIG. 5. In the report depicted, each line is a separate entry.

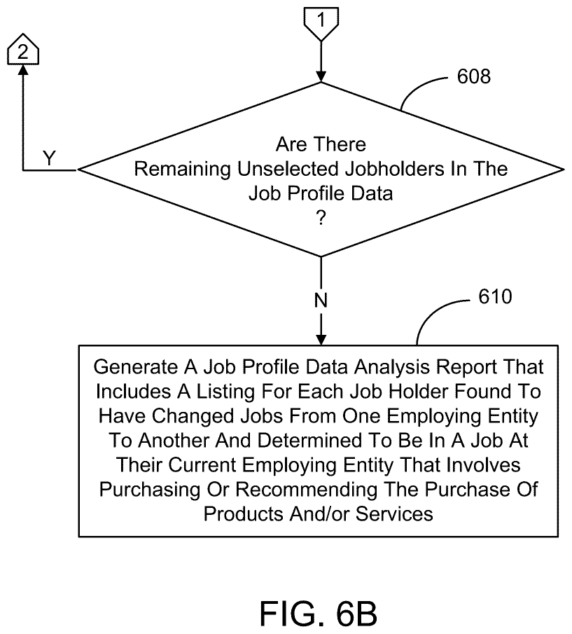

FIGS. 6A-B illustrates an exemplary process for analyzing job profile data, which in one implementation of the job profile data analysis described herein is realized using the system framework illustrated in FIG. 1. As exemplified in FIGS. 6A-B, the process starts with accessing job profile data collected over a prescribed period of time (process action 600). For example, in one version the prescribed period of time is 90 days. This job profile data includes, but is not limited to job holder identifiers, as well as at least one of job titles, job descriptions, job locations, functional areas of an employing entity, start dates of jobs, end dates of jobs, and employing entity information including an employing entity identifier, that are associated with each job holder. A previously unselected job holder found in the job profile data is selected (process action 602), and the job profile data is analyzed to identify if the selected job holder has changed jobs from one employing entity to another (process action 604). If it is found that the selected job holder has changed jobs from one employing entity to another, it is next determined if the job holder is in a job at their current employing entity that involves purchasing or recommending the purchase of products, or services, or both (process action 606). If so, or if it is found that the selected job holder has not changed jobs from one employing entity to another or it is determined that the selected job holder is not in a job at their current employing entity that involves purchasing or recommending the purchase of products, or services, or both, then it is determined if there are remaining unselected job holders in the job profile data (process action 608). If there are remaining unselected job holders, then the process repeats starting with process action 602. If not, a job profile data analysis report is generated that includes a listing for each job holder found to have changed jobs from one employing entity to another and determined to be in a job at their current employing entity that involves purchasing or recommending the purchase of products, or services, or both (process action 610).

2.0 Identifying Marketing And Sales Opportunities and Threats

Once the job profile data analysis report is generated, information about the old and new employing entities associated with a job change is accessed and analyzed to identity marketing and sales opportunities and threats. More particularly, information about what products and services were used by the old employing entity in the functional area where the individual who changed jobs used to work, as well as what products and services are used by the new employing entity in the functional area where the individual who changed jobs is now working, is accessed. Such information is commercially available or can be collected using appropriate methods such as those described in “U.S. patent application Ser. No. 17/193,992, Unpublished (filing date Mar. 5, 2021) (HG Insights Inc., applicant)”.

Useful insights can be gleaned from knowing that an individual has moved to a new employing entity to take a job where he or she has decision making or influencing power over what products or services are used by the new employing entity, and knowing what products and services were used in the functional areas the individual worked in at his or her old and new employing entities. One useful insight is that if a product or service was used in a functional area where an individual worked in their old employing entity, and the product or service is not used in the functional area where the individual now works in the new employing entity (even if it is not the same type of functional area), or if the same type of product or service is used but from a different vendor, there is a greater likelihood that that such an individual would be receptive to marketing overtures for the missing/different product or service.

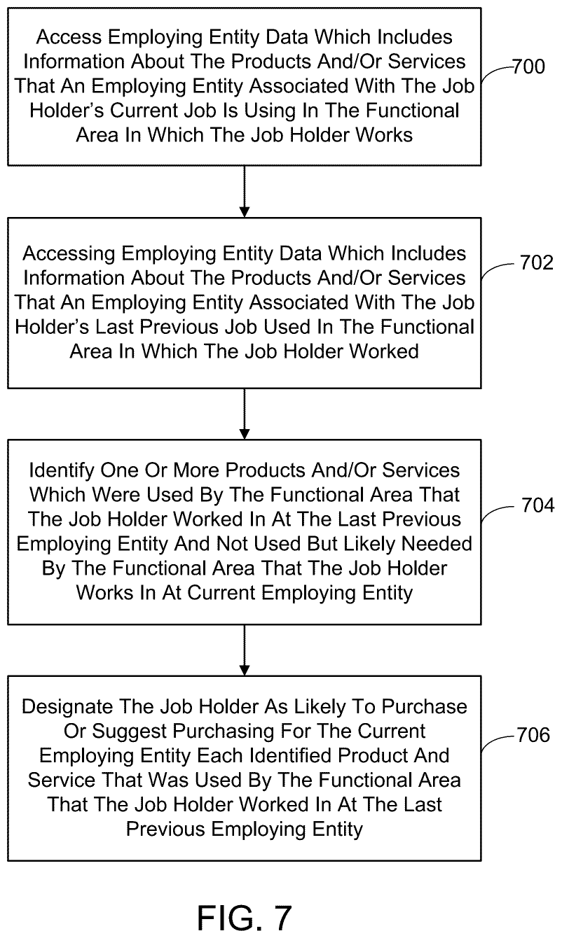

For example, referring to FIG. 7, in one implementation where the product or service is not used in the functional area where the above described individual now works in the new employing entity, the job profile data analysis computer program includes sub-programs that access employing entity data which includes information about the products, or services, or both, an employing entity associated with the job holder's current job is using in the functional area that the job holder works in at current employing entity (process action 700), as well as accessing employing entity data which includes information about the products, or services, or both, an employing entity associated with the job holder's last previous job used in the functional area that the job holder worked in at the last previous employing entity (process action 702). Next, one or more products or services, or both, are identified which were used by the functional area that the job holder worked in at the last previous employing entity and not used but likely needed by the functional area that the job holder works in at current employing entity (process action 704). The job holder is then designated as likely to purchase or suggest purchasing for the current employing entity each identified product and service that was used by the functional area that the job holder worked in at the last previous employing entity (process action 706). In one version, this designating entails designating the job holder as likely to purchase or suggest purchasing for the current employing entity each identified product and service that was used by the functional area that the job holder worked in at the last previous employing entity and provided by a same vendor as an identified product or service that was used by the functional area that the job holder worked in at the last previous employing entity.

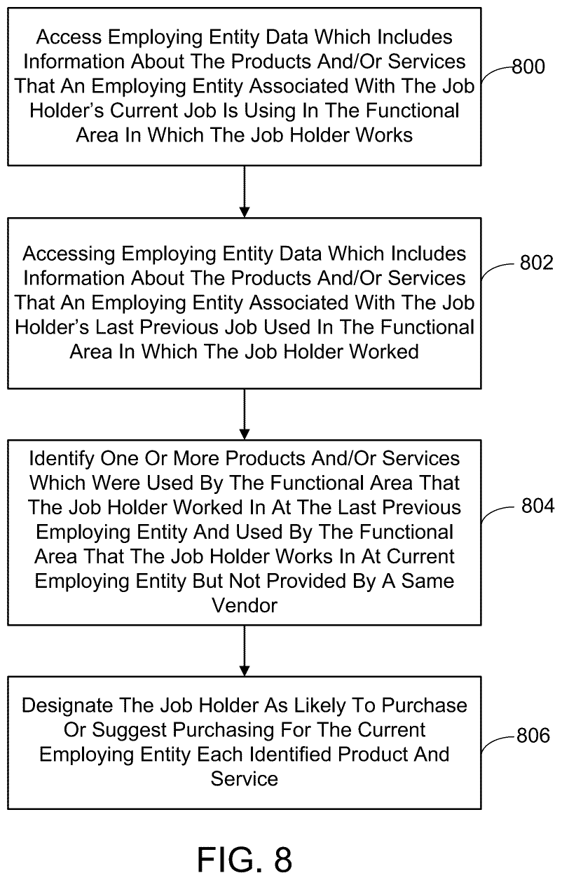

Referring now to FIG. 8, in one implementation where the product or service is used in the functional area where the above described individual now works in the new employing entity but from a different vendor, the job profile data analysis computer program includes sub-programs that access employing entity data which includes information about the products, or services, or both, an employing entity associated with the job holder's current job is using in the functional area that the job holder works in at current employing entity (process action 800), as well as accessing employing entity data which includes information about the products, or services, or both, an employing entity associated with the job holder's last previous job used in the functional area that the job holder worked in at the last previous employing entity (process action 802). Next, one or more products or services, or both, are identified which were used by the functional area that the job holder worked in at the last previous employing entity and used by the functional area that the job holder works in at current employing entity but not provided by a same vendor (process action 804). The job holder is then designated as likely to purchase or suggest purchasing for the current employing entity each identified product and service (process action 806). In one version, this designating entails designating the job holder as likely to purchase or suggest purchasing for the current employing entity each identified product and service provided by a same vendor as an identified product or service that was used by the functional area that the job holder worked in at the last previous employing entity.

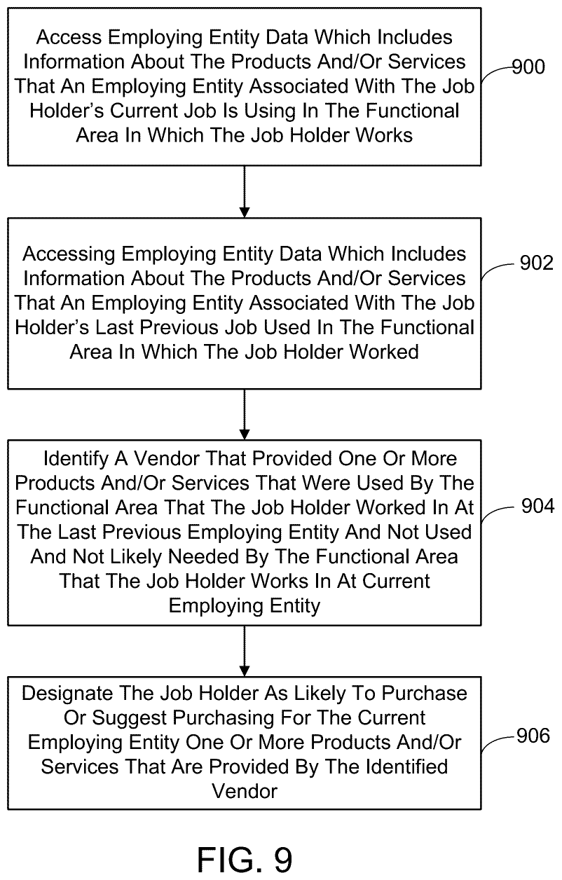

If it is known that the new employing entity lacks maturity with respect to using certain products and services, this would be an even greater indicator that the newly hired decision maker or influencer would be receptive to marketing overtures for these products or services. The same is true even if a missing product or service is not needed in the functional area of the new employing entity where the individual now works, but there is a need for a different product offered by the same vendor as the missing product (i.e., appealing to brand loyalty). For example, referring to FIG. 9, in one implementation where the product or service is not needed in the functional area of the new employing entity where the previously described individual now works, the job profile data analysis computer program includes sub-programs that access employing entity data which includes information about the products, or services, or both, an employing entity associated with the job holder's current job is using in the functional area that the job holder works in at current employing entity (process action 900), as well as accessing employing entity data which includes information about the products, or services, or both, an employing entity associated with the job holder's last previous job used in the functional area that the job holder worked in at the last previous employing entity (process action 902). Next, a vendor is identified that provided one or more products or services, or both, that were used by the functional area that the job holder worked in at the last previous employing entity and not used and not likely needed by the functional area that the job holder works in at current employing entity (process action 904). The job holder is then designated as likely to purchase or suggest purchasing for the current employing entity one or more products or services, or both, that are provided by the identified vendor (process action 906).

Another example of the usefulness of the decision maker/influencer status information for a job holder's current and previous jobs involves a job holder that did not have purchasing or influencing power in their previous position but takes on that role at a new employing entity. Such a person is of particular interest to potential vendors of products and services of the type that would be purchased by this job holder in their new job since this person may not be known or have a relationship with the incumbent vendors for the employing entity, and the job holder may not have any pre-existing preferential bias as the source of the products or services since they were not involved in purchasing decisions in their previous job. As such, the job holder may be more receptive to marketing overtures by a vendor than they would have been otherwise.

Knowing that an individual has moved to a new employing entity to take a job where he or she has decision making or influencing power over what products or services are used by the new employing entity, and knowing what products and services were used in the functional areas the individual worked in at his or her old and new employing entities would also be useful to a third-party vendor to alert them of an opportunity to sell their product or service if it is missing, or supplant a product or service used in the functional area of the new employing entity where the individual now works by convincing the individual that their product or service is superior or a better buy than the product or service the individual is familiar with from their job at their old employing entity.

Another useful insight is that if a product or service was used in a functional area where an individual worked in their old employing entity and the same type of product or service is used in their new job but from a different vendor, that vendor would find this information useful so that efforts could be made to convince the individual to retain their product or service.

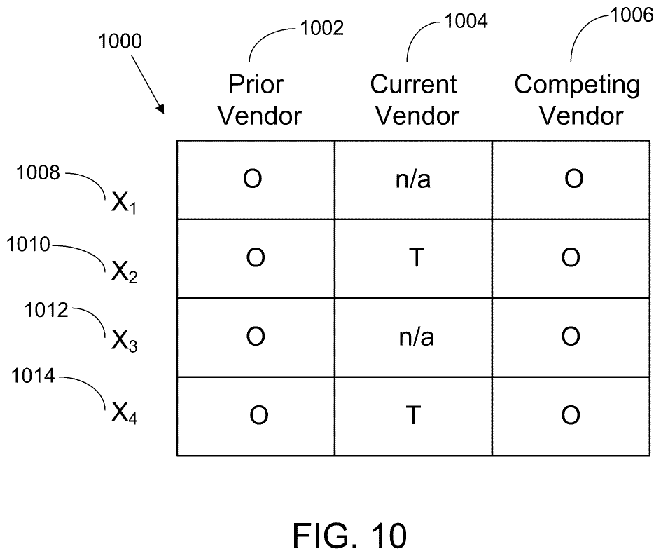

The marketing and sales opportunities and threats described previously can be summarized in the table 1000 shown in FIG. 10. In general, there are three potential actors involved in each of the scenarios described previously. Namely, a vendor of technology at a prior employing entity 1002, a vendor of technology at the current employing entity 1004, and a vendor of technology that competes with one or both of these vendors 1006. These vendors 1002, 1004, 1006 form the columns of the table 1000. Various exemplary scenarios S₁ through S₄ form the rows of the table 1000. More particularly, S₁ 1008 represents a scenario where one or more products or services, or both, were used by the functional area that the job holder worked in previously and not used but likely needed by the functional area that the job holder works in currently. It is noted that in the foregoing scenario and the scenarios that will be described shortly, it is assumed that a job holder has changed jobs and has been determined to be in a current job that involves purchasing or recommending the purchase of products, or services, or both. S₂ 1010 represents a scenario where one or more products or services, or both, were used by the functional area that the job holder worked in previously and used by the functional area that the job holder works in currently, but not provided by a same vendor. S₃ 1012 represents a scenario where a vendor provided one or more products or services, or both, that were used by the functional area that the job holder worked in previously, and which are not used and not likely needed by the functional area that the job holder works in currently. And S₄ 1014 represents a scenario where one or more products or services, or both, are used by the functional area that the job holder works in currently, not used by the functional area that the job holder worked in previously, but the current products and/or services are not provided by a vendor familiar to the job holder. It is noted that the foregoing scenarios are just examples. Other scenarios are possible, and it is not intended to limit the job profile data analysis implementations described herein to just those scenarios described above. As is illustrated in the table 1000 of FIG. 10, each of the listed scenarios 1008, 1010, 1012, 1014 represents either a marketing and/or sales opportunity (O) or threat (T) to the listed vendors 1002, 1004, 1006, or is not applicable (n/a). Thus, each of the listed scenarios 1008, 1010, 1012, 1014 represents an opportunity to a vendor 1002 that provided one or more products or services, or both, that were used by the functional area that the job holder worked in previously, as well as to a vendor 1006 that competes with the prior 1002 or current vendor 1004, or both. These opportunities primarily arise from the job holder being familiar with the previous vendor and/or because the job holder is not familiar with the current vendor. On the other hand, the scenarios 1010 and 1014 where a current vendor 1004 is involved, represent marketing and/or sales threats to that vendor since there is a risk of losing business to the other vendors 1002, 1006.

3.0 Other Implementations

While job profile data analysis techniques have been described by specific reference to implementations thereof, it is understood that variations and modifications thereof can be made without departing from the true spirit and scope. For example, while the job profile data analysis implementation described so far have focused on individuals that that recently changed jobs from one employing entity to another, useful marketing and sales incites can also be gleaned from knowing that an individual has changed jobs within the same employing entity and is now in a decision maker or influencer role in their new job.

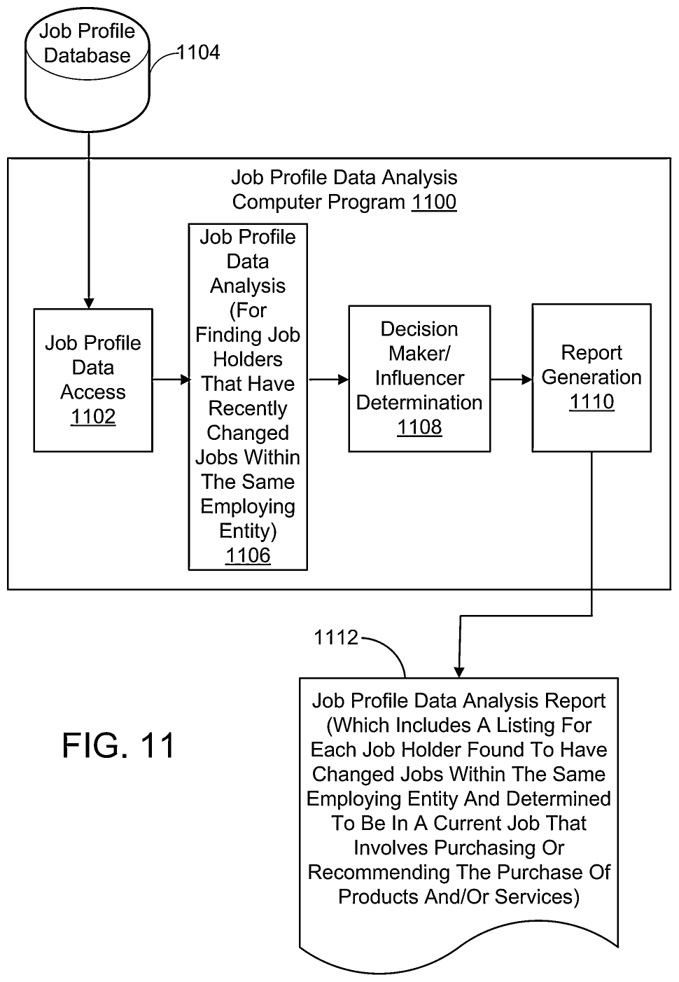

FIG. 11 illustrates one implementation, in simplified form, of the sub-programs included in the job profile data analysis computer program 1100 that configure the aforementioned computing device or devices. More particularly, a job profile data access sub-program 1102 is included as shown in FIG. 11. The access sub-program 1102 receives input data from a job profile database 1104, such as the one described previously. The job profile data analysis computer program 1100 also includes a job profile data analysis sub-program 1106 as shown in FIG. 11. In general, the analysis sub-program 1006 uses the job profile data to identify job holders that have recently (e.g., in the last 90 days) changed jobs. In this case, job holders that have changed jobs within the same employing entity are identified. The job profile data analysis computer program 1100 further includes a decision maker/influencer determination sub-program 1108. In general, the determination sub-program 1108 uses the job profile data to determine if a job holder is in a job which involves purchasing or recommending the purchase of products, or services, or both. This is done for each job holder previously found to have changed jobs within the same employing entity using the methods described previously. It is also advantageous to know if an identified job holder was a decision maker or influencer in their previous job. The previously described procedures for determining the job holder's decision maker/influencer/individual status are employed to determine if the job holder was a decision maker or influencer in their previous job (or not). Referring once again to FIG. 11, the job profile data analysis computer program 1100 further includes a report generation sub-program 1110. In general, the report generation sub-program 1110 generates a job profile data analysis report 1112 the includes a listing for each job holder found to have changed jobs within the same employing entity and determined to be in a current job that involves purchasing or recommending the purchase of products, or services, or both.

Useful insights can be gleaned from knowing that an individual has moved to a new job within the same employing entity and has decision making or influencing power over what products or services are purchased. Information about what products and services were used by the employing entity in the functional area where the individual who changed jobs used to work, as well as what products and services are used by the employing entity in the functional area where the individual who changed jobs is now working, is accessed and analyzed to identity marketing and sales opportunities and threats. The insights that can be gleaned from the foregoing knowledge are similar to those gleaned when a job holder changes jobs and moves to a new employing entity. For example, one useful insight is that if a product or service was used in a functional area where an individual worked previously, and the product or service is not used in a different functional area where the individual now works, or if the same type of product or service is used but from a different vendor, there is a greater likelihood that that such an individual would be receptive to marketing overtures for the missing product or service. The processes illustrated in FIGS. 7 and 8 can be modified to identity a job holder that is likely to purchase or suggest purchasing products and/or services in their new job by, instead of accessing information about the products, or services, or both, associated with a current and previous employing entity, this information is accessed for a current and previous functional area within the same employing entity.

Other insights also exist. For example, if a product or service used in a job holder's previous functional area is not needed in the functional area where a job holder now works, but there is a need for a different product or service offered by the same vendor as the missing product, the job holder may be more likely to purchase or suggest purchasing products and/or services supplied by that vendor in their new job (i.e., appealing to brand loyalty). The process illustrated in FIG. 9 can be modified to identity a job holder that is likely to purchase or suggest purchasing products and/or services in their new job which are supplied by a vendor he or she is familiar with from their previous job in a different functional area of the employing entity by, instead of accessing information about the products, or services, or both, associated with a current and previous employing entity, this information is accessed for a current and previous functional area within the same employing entity.

Knowing the decision maker/influencer status for a job holder's current and previous jobs is also useful if a job holder that did not have purchasing or influencing power in their previous position but takes on that role in their new job within the same employing entity. Such a person is of particular interest to potential vendors of products and services of the type that would be purchased by this job holder in their new job since this person may not be known or have a relationship with the incumbent vendors, and the job holder may not have any pre-existing preferential bias as the source of the products or services since they were not involved in purchasing decisions in their previous job. As such, the job holder may be more receptive to marketing overtures by a vendor than they would have been otherwise. This can apply even if the job holder was promoted to a new job with decision making or influencer powers in the same functional area of the employing entity. Further, knowing that an individual has moved to a new job within the same employing entity where he or she has decision making or influencing power over what products or services are purchased, and knowing what products and services were used in the functional areas the individual worked in at his or her old job and in his or her new job would also be useful to a third-party vendor to alert them of an opportunity to sell their product or service if it is missing, or supplant a product or service used in the functional area of the employing entity where the individual now works by convincing the individual that their product or service is superior or a better buy than the product or service the individual is familiar with from their old job within the same employing entity. Yet another useful insight is that if a product or service was used in a functional area where an individual worked in at an employing entity and the same type of product or service is used but from a different vendor in a functional area where the individual now works within the same employing entity, that vendor would find this information useful so that efforts could be made to convince the individual to retain their product or service.

It is further noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

4.0 Exemplary Operating Environments

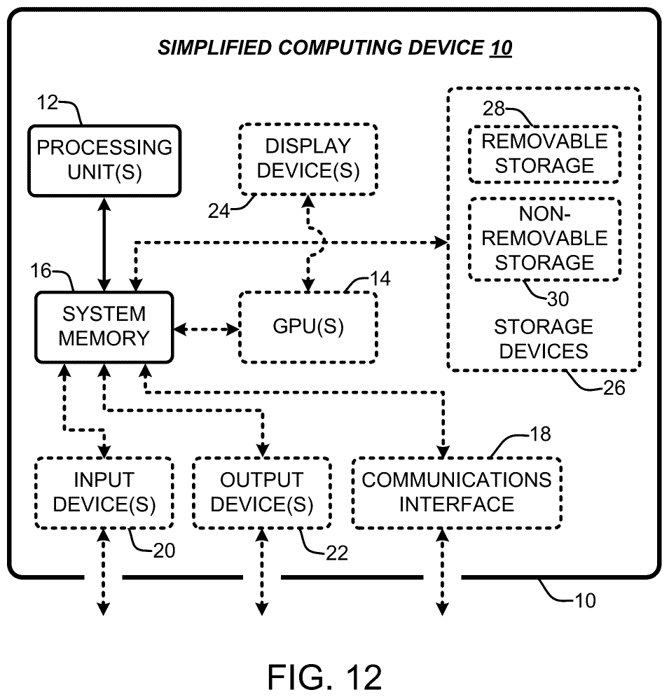

The job profile data analysis implementations described herein are operational within numerous types of general purpose or special purpose computing system environments or configurations. FIG. 12 illustrates a simplified example of a general-purpose computer system on which various implementations and elements of the job profile data analysis, as described herein, may be implemented. It is noted that any boxes that are represented by broken or dashed lines in the simplified computing device 10 shown in FIG. 12 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the job profile data analysis implementations described herein, the device should have a sufficient computational capability and system memory to enable basic computational operations. In particular, the computational capability of the simplified computing device 10 shown in FIG. 12 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the job profile data analysis implementations described herein, including input, output, control, feedback, and response to one or more users or other devices or systems associated with the job profile data analysis implementations, are enabled by a variety of Natural User Interface (NUI) scenarios. The NUI techniques and scenarios enabled by the job profile data analysis implementations include, but are not limited to, interface technologies that allow one or more users to interact with the job profile data analysis implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the job profile data analysis implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the job profile data analysis implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 12 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various job profile data analysis implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The job profile data analysis implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The job profile data analysis implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor. Still further, the job profile data analysis implementations described herein can be virtualized and realized as a virtual machine running on a computing device such as any of those described previously. In addition, multiple job profile data analysis virtual machines can operate independently on the same computer device.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for analyzing job profile data, comprising:
a job profile data analyzer comprising one or more computing devices, and a job profile data analysis computer program having a plurality of sub-programs executable by said computing device or devices, wherein the sub-programs configure said computing device or devices to,
access job profile data collected over a prescribed period of time, said job profile data comprising job holder identifiers, as well as at least one of job titles, job descriptions, job locations, functional areas of an employing entity, start dates of jobs, end dates of jobs, and employing entity information including an employing entity identifier, that are associated with each job holder,
analyze the job profile data to identify job holders that have changed jobs from one employing entity to another,
for each job holder found to have changed jobs from one employing entity to another, determine if the job holder is in a job at their current employing entity that involves purchasing or recommending the purchase of products, or services, or both, and
generate a report comprising a listing for each job holder found to have changed jobs from one employing entity to another and determined to be in a job at their current employing entity that involves purchasing or recommending the purchase of products, or services, or both.

2. The system of claim 1, wherein the job profile data comprises start dates of jobs, end dates of jobs, and employing entity information associated with each identified job holder, and wherein the sub-program to analyze the job profile data to identify job holders that have changed jobs from one employing entity to another, comprises employing the job start dates and job end dates to identify a job holder's last previous employing entity and the job holder's current employing entity.

3. The system of claim 1, wherein each listing in the report comprises the job holder identifier associated with a job holder, the identifier associated with the job holder's current employing entity, the job title associated with the job holder's current job, and the name of the functional areas of the current employing entity associated with the job holder's current job.

4. The system of claim 1, wherein the job profile data analysis computer program further comprises sub-programs to:
for each job holder found to have changed jobs from one employing entity to another within the prescribed period of time associated with the job profile data and determined to be in a job at their current employing entity that involves purchasing or recommending the purchase of products, or services, or both,
accessing employing entity data comprising information about the products, or services, or both, an employing entity associated with the job holder's current job is using in the functional area that the job holder works in at current employing entity,
accessing employing entity data comprising information about the products, or services, or both, an employing entity associated with the job holder's last previous job used in the functional area that the job holder worked in at the last previous employing entity,
identifying one or more products or services, or both, that were used by the functional area that the job holder worked in at the last previous employing entity and not used but likely needed by the functional area that the job holder works in at current employing entity, and
designating the job holder as likely to purchase or suggest purchasing for the current employing entity each identified product and service that was used by the functional area that the job holder worked in at the last previous employing entity.

5. The system of claim 4, wherein the sub-program for designating the job holder as likely to purchase or suggest purchasing for the current employing entity each identified product and service that was used by the functional area that the job holder worked in at the last previous employing entity, comprises designating the job holder as likely to purchase or suggest purchasing for the current employing entity each identified product and service that was used by the functional area that the job holder worked in at the last previous employing entity and provided by a same vendor as an identified product or service that was used by the functional area that the job holder worked in at the last previous employing entity.

6. The system of claim 1, wherein the job profile data analysis computer program further comprises sub-programs to:
for each job holder found to have changed jobs from one employing entity to another within the prescribed period of time associated with the job profile data and determined to be in a job at their current employing entity that involves purchasing or recommending the purchase of products, or services, or both,
accessing employing entity data comprising information about the products, or services, or both, an employing entity associated with the job holder's current job is using in the functional area that the job holder works in at current employing entity,
accessing employing entity data comprising information about the products, or services, or both, an employing entity associated with the job holder's last previous job used in the functional area that the job holder worked in at the last previous employing entity,
identify one or more products or services, or both, that were used by the functional area that the job holder worked in at the last previous employing entity and used by the functional area that the job holder works in at current employing entity but not provided by a same vendor as the one or more products or services, or both, that were used by the functional area that the job holder worked in at the last previous employing entity, and
designating the job holder as likely to purchase or suggest purchasing for the current employing entity each identified product and service.

7. The system of claim 6, wherein the sub-program for designating the job holder as likely to purchase or suggest purchasing for the current employing entity each identified product and service, comprises designating the job holder as likely to purchase or suggest purchasing for the current employing entity each identified product and service provided by a same vendor as an identified product or service that was used by the functional area that the job holder worked in at the last previous employing entity.

8. The system of claim 1, wherein the job profile data analysis computer program further comprises sub-programs to:
for each job holder found to have changed jobs from one employing entity to another within the prescribed period of time associated with the job profile data and determined to be in a job at their current employing entity that involves purchasing or recommending the purchase of products, or services, or both,
accessing employing entity data comprising information about the products, or services, or both, an employing entity associated with the job holder's current job is using in the functional area that the job holder works in at current employing entity,
accessing employing entity data comprising information about the products, or services, or both, an employing entity associated with the job holder's last previous job used in the functional area that the job holder worked in at the last previous employing entity,
identifying a vendor that provided one or more products or services, or both, that were used by the functional area that the job holder worked in at the last previous employing entity and not used and not likely needed by the functional area that the job holder works in at current employing entity, and
designating the job holder as likely to purchase or suggest purchasing for the current employing entity one or more products or services, or both, that are provided by the identified vendor.

9. The system of claim 1, wherein the job profile data comprises job titles associated with the identified job holders, and wherein the sub-program to determine if a job holder is in a job at their current employing entity that involves purchasing or recommending the purchase of products, or services, or both, comprises:
accessing a database of job titles that are indicative of a job holder whose job includes purchasing or recommending the purchase of products, or services, or both;
ascertaining if the job title associated with a job holder under consideration at their current employing entity is listed in the job titles database as being indicative of a job holder whose job includes purchasing or recommending the purchase of products, or services, or both; and
designating that the job holder under consideration is in a job at their current employing entity that involves purchasing or recommending the purchase of products, or services, or both whenever the job title associated with the job holder under consideration at their current employing entity is listed in the job titles database as being indicative of a job holder whose job includes purchasing or recommending the purchase of products, or services.

10. The system of claim 1, wherein the job profile data comprises job titles associated with the identified job holders and functional areas of an employing entity associated with the identified job holders, and wherein the sub-program to determine if a job holder is in a job at their current employing entity that involves purchasing or recommending the purchase of products, or services, or both, comprises:
accessing a database of job title and functional area combinations that are indicative of a job holder whose job includes purchasing or recommending the purchase of products, or services, or both;
ascertaining if the job title and functional area combination associated with a job holder under consideration at their current employing entity is listed in the job title and functional area database as being indicative of a job holder whose job includes purchasing or recommending the purchase of products, or services; and
designating that the job holder under consideration is in a job at their current employing entity that involves purchasing or recommending the purchase of products, or services, or both whenever the job title and functional area combination associated with the job holder under consideration at their current employing entity is listed in the job title and functional area database as being indicative of a job holder whose job includes purchasing or recommending the purchase of products, or services.

11. The system of claim 1, wherein the job profile data comprises job titles associated with the identified job holders, and wherein the sub-program to determine if a job holder is in a job at their current employing entity that involves purchasing or recommending the purchase of products, or services, or both, comprises employing a job title classifier to identify if a job holder is in a job at their current employing entity that involves purchasing or recommending the purchase of products, or services, or both.

12. The system of claim 11, wherein employing a job title classifier, comprises employing a supervised machine learning technique which is trained using a plurality of input-output examples, said input of each input-output example comprising a job title derived from the job profile data and said output of each input-output example comprising an indicator indicating if a job holder having the input job title of the input-output example is in a job that involves purchasing or recommending the purchase of products, or services, wherein the job title classifier once trained comprises an inferring function that identifies if a job holder is in a job that involves purchasing or recommending the purchase of products, or services based on an input comprising a job title.

13. The system of claim 1, wherein the job profile data comprises job titles associated with the identified job holders and functional areas of an employing entity associated with the identified job holders, and wherein the sub-program to determine if a job holder is in a job at their current employing entity that involves purchasing or recommending the purchase of products, or services, or both, comprises employing a job title-functional area classifier to identify if a job holder is in a job at their current employing entity that involves purchasing or recommending the purchase of products, or services, or both.

14. The system of claim 13, wherein employing a job title-functional area classifier, comprises employing a supervised machine learning technique which is trained using a plurality of input-output examples, said input of each input-output example comprising a job title and functional area combination derived from the job profile data and said output of each input-output example comprising an indicator indicating if a job holder having the input job title-functional area combination of the input-output example is in a job that involves purchasing or recommending the purchase of products, or services, wherein the job title-functional area classifier once trained comprises an inferring function that identifies if a job holder is in a job that involves purchasing or recommending the purchase of products, or services based on an input comprising a job title-functional area combination.

15. A system for analyzing job profile data, comprising:
a job profile data analyzer comprising one or more computing devices, and a job profile data analysis computer program having a plurality of sub-programs executable by said computing device or devices, wherein the sub-programs configure said computing device or devices to,
access job profile data collected over a prescribed period of time, said job profile data comprising job holder identifiers, as well as at least one of job titles, job descriptions, job locations, functional areas of an employing entity, start dates of jobs, end dates of jobs, and employing entity information including an employing entity identifier, that are associated with each job holder,
analyze the job profile data to identify job holders that have changed jobs within an employing entity,
for each job holder found to have changed jobs within an employing entity, determine if the job holder's current job at their employing entity involves purchasing or recommending the purchase of products, or services, or both, and
generate a report comprising a listing for each job holder found to have changed jobs within an employing entity and whose current job at their employing entity involves purchasing or recommending the purchase of products, or services, or both.

16. The system of claim 15, wherein the job profile data analysis computer program further comprises sub-programs to:
for each job holder found to have changed jobs within an employing entity and determined to hold a current job at their employing entity that involves purchasing or recommending the purchase of products, or services, or both,
accessing employing entity data comprising information about the products, or services, or both, the employing entity is using in the functional area that the job holder currently works in at the employing entity,
accessing employing entity data comprising information about the products, or services, or both, the employing entity used in the last previous functional area that the job holder worked in at the employing entity,
identifying one or more products or services, or both, that were used by the last previous functional area that the job holder worked in at employing entity and not used but likely needed by the functional area that the job holder currently works in at the employing entity, and
designating the job holder as likely to purchase or suggest purchasing for the employing entity each identified product and service that was used by the last previous functional area that the job holder worked in at the employing entity.

17. The system of claim 16, wherein the sub-program for designating the job holder as likely to purchase or suggest purchasing for the employing entity each identified product and service that was used by the last previous functional area that the job holder worked in at the employing entity, comprises designating the job holder as likely to purchase or suggest purchasing for the employing entity each identified product and service that was used by the last previous functional area that the job holder worked in at the employing entity and provided by a same vendor as an identified product or service that was used by the last previous functional area that the job holder worked in at the employing entity.

18. The system of claim 15, wherein the job profile data analysis computer program further comprises sub-programs to:
for each job holder found to have changed jobs within an employing entity and determined to hold a current job at their employing entity that involves purchasing or recommending the purchase of products, or services, or both,
accessing employing entity data comprising information about the products, or services, or both, the employing entity is using in the functional area that the job holder currently works in at the employing entity,
accessing employing entity data comprising information about the products, or services, or both, the employing entity used in the last previous functional area that the job holder worked in at the employing entity,
identify one or more products or services, or both, that were used by the last previous functional area of the employing entity that the job holder worked in and used by the functional area of the employing entity that the job holder currently works in but not provided by a same vendor as the one or more products or services, or both, that were used by the last previous functional area of the employing entity that the job holder worked in, and
designating the job holder as likely to purchase or suggest purchasing for the employing entity each identified product and service.

19. The system of claim 18, wherein the sub-program for designating the job holder as likely to purchase or suggest purchasing for the employing entity each identified product and service, comprises designating the job holder as likely to purchase or suggest purchasing for the employing entity each identified product and service provided by a same vendor as an identified product or service that was used by the last previous functional area of the employing entity that the job holder worked i.

20. The system of claim 15, wherein the job profile data analysis computer program further comprises sub-programs to:
for each job holder found to have changed jobs within an employing entity and determined to hold a current job at their employing entity that involves purchasing or recommending the purchase of products, or services, or both,
accessing employing entity data comprising information about the products, or services, or both, the employing entity is using in the functional area that the job holder currently works in at the employing entity,
accessing employing entity data comprising information about the products, or services, or both, the employing entity used in the last previous functional area that the job holder worked in at the employing entity,
identifying a vendor that provided one or more products or services, or both, that were used by the last previous functional area that the job holder worked in at the employing entity and not used and not likely needed by the functional area that the job holder currently works in at the employing entity, and
designating the job holder as likely to purchase or suggest purchasing for the employing entity one or more products or services, or both, that are provided by the identified vendor.

21. A computer-implemented process for analyzing job profile data, the process comprising the actions of:
using one or more computing devices to perform the following process actions, the computing devices being in communication with each other via a computer network whenever a plurality of computing devices is used:
accessing job profile data collected over a prescribed period of time, said job profile data comprising job holder identifiers, as well as at least one of job titles, job descriptions, job locations, functional areas of an employing entity, start dates of jobs, end dates of jobs, and employing entity information including an employing entity identifier, that are associated with each job holder;
analyzing the job profile data to identify job holders that have changed jobs from one employing entity to another;
for each job holder found to have changed jobs from one employing entity to another, determining if the job holder is in a job at their current employing entity that involves purchasing or recommending the purchase of products, or services, or both; and
generating a report comprising a listing for each job holder found to have changed jobs from one employing entity to another and determined to be in a job at their current employing entity that involves purchasing or recommending the purchase of products, or services, or both.
